(19) United States
(12) Patent Application Publication
(10) Pub. No.: US 2017/0331218 A1
(43) Pub. Date: Nov. 16, 2017

(54) USB 3.1 TYPE-C STACKING CONNECTOR STRUCTURE

(71) Applicant: PORTWELL INC., New Taipei City (TW)

(72) Inventor: CHENG-HAN CHANG, NEW TAIPEI CITY (TW)

(21) Appl. No.: 15/364,709

(22) Filed: Nov. 30, 2016

(30) Foreign Application Priority Data
May 10, 2016 (TW) 105206732

(51) Int. Cl. H01R 13/514; H01R 13/518; H01R 24/60; H01R 107/00

(52) U.S. Cl. CPC H01R 13/514; H01R 24/60; H01R 13/518; H01R 2107/00

(57) ABSTRACT

A USB 3.1 Type-C stacking connector structure includes a first Type-C connector; a second Type-C connector, and a stacking seat. The first Type-C connector and the second Type-C connector are fixed onto both sides of the stacking seat respectively to form a USB 3.1 Type-C stacking connector assembly, so as to expand the transmission speed and the current performance of the Type-C and broaden the scope of applicability and the room for market development to improve the applications and economic benefits of the related product.

### FIELD OF THE INVENTION

The present invention relates to a stacking connector structure, and more particularly to a USB 3.1 Type-C stacking connector structure designated for a USB 3.1 Type-C stacking assembly and providing a broader scope of applicability.

### BACKGROUND OF THE INVENTION

### 1. Description of the Related Art

USB Type-C is a specification for a brand new design of connection interface specified by USB 3.1 chips. Since USB Type-C can provide a transmission bandwidth up to 10 Gbit/s for applications and products and also possesses a better power management efficiency, therefore the USB Type-C has been gradually applied to mobile consumer devices and has demonstrated its high-speed transmission performance and high charging power. Since a thin and light product design is a basic requirement of mobile consumer devices and the thickness is a major issue of mobile consumer products, the stacking connection is generally inapplicable, so that manufacturers developed and introduced a stackless Type-C connector. Besides the mobile consumer devices, USB 3.1 can provide higher transmission rate and current (5A), so that the USB 3.1 still can be applied to other fields or specific fields such as the application for testing in factories or the management of mobile devices. Therefore, it is a main subject for related manufacturers to find a feasible solution of applying the Type-C stacking connectors in future expected fields in order to meet market and application requirements.

In view of the drawbacks and issues of structural design of the conventional Type-C connectors, the inventor of the present invention conducted extensive researches and experiments, and finally developed a USB 3.1 Type-C stacking connector structure capable of broadening the scope of Type-C applications to promote the related industry.

### 2. Summary of the Invention

Therefore, it is a primary objective of the present invention to provide a

To achieve the aforementioned and other objectives, the present invention provides a USB 3.1 Type-C stacking connector structure capable of forming a Type-C double-deck connector from a Type-C stacking assembly to achieve the effects of maximizing the transmission rate and the current performance of the Type-C, expanding the scope of applicability and the room for market development, so as to improve the applications and economic benefits of the related product.

To achieve the aforementioned and other objectives, the present invention provides a technical measure comprising: a first Type-C connector; a second Type-C connector; and a stacking seat, wherein the first Type-C connector and the second Type-C connector are onto both sides of the stacking seat respectively to form a USB 3.1 Type-C stacking connector assembly.

In the aforementioned assembly, the first Type-C connector comprises a first insulating body, a plurality of first terminals, and a first steel casing, wherein a first flap is protruded form the front end of the first insulating body, and the first flap has a plurality of first terminal grooves formed on both upper and lower sides, and the first steel casing covers the first insulating body and the plurality of first terminals, and the first steel casing has a first docking opening formed at the front end of the first steel casing.

In the aforementioned assembly, the first insulating body has a plurality of latching elements installed thereon, and the first steel casing has a plurality of retaining grooves for latching the latching elements respectively.

In the aforementioned assembly, the first terminal includes a front-section first connecting terminal and a rear-section bent first adapting terminal, and the first connecting terminal is installed into the first terminal groove formed on the upper side of the first flap.

In the aforementioned assembly, the first steel casing has a plurality of first retaining legs formed thereon.

In the aforementioned assembly, the second Type-C connector includes a second insulating body, a plurality of second terminals and a second steel casing, and the second insulating body has a second flap protruded from the front end of the second insulating body, and the second flap has a plurality of second terminal groove formed on both upper and lower sides of the second flap, and the second steel casing covers the second insulating body and the plurality of second terminals, and the second steel casing has a second docking opening formed at the front end of the second steel casing.

In the aforementioned assembly, the second insulating body has a plurality of latching elements, and the second steel casing has a plurality of retaining grooves latched to the latching elements respectively.

In the aforementioned assembly, the second terminal includes a front-section second connecting terminal and a rear-section bent second adapting terminal, and the second connecting terminal is disposed in the second terminal groove formed on the upper side of the second flap.

In the aforementioned assembly, the second steel casing has a plurality of second retaining legs formed thereon.

In the aforementioned assembly, the stacking seat has an upper first positioning portion and a lower second positioning portion, and the first positioning portion is provided for installing and positioning the first Type-C connector, and the second positioning portion is provided for installing and positioning the second Type-C connector, and the first positioning portion and the second positioning portion are preferably in shape of a groove.

In the aforementioned assembly, the first Type-C connector is fixed to the first positioning portion by latching or tight positioning, and the second Type-C connector is fixed to the second positioning portion by latching or tight positioning.

### BRIEF DESCRIPTION OF THE DRAWINGS

FIG. 1 is an exploded view of the present invention;

FIG. 2A is a front view of the present invention;

FIG. 2B is a side view of the present invention; and

FIG. 3 is a perspective view of the present invention;

### DESCRIPTION OF THE PREFERRED EMBODIMENTS

The above and other objects, features and advantages of this disclosure will become apparent from the following detailed description taken with the accompanying drawings.

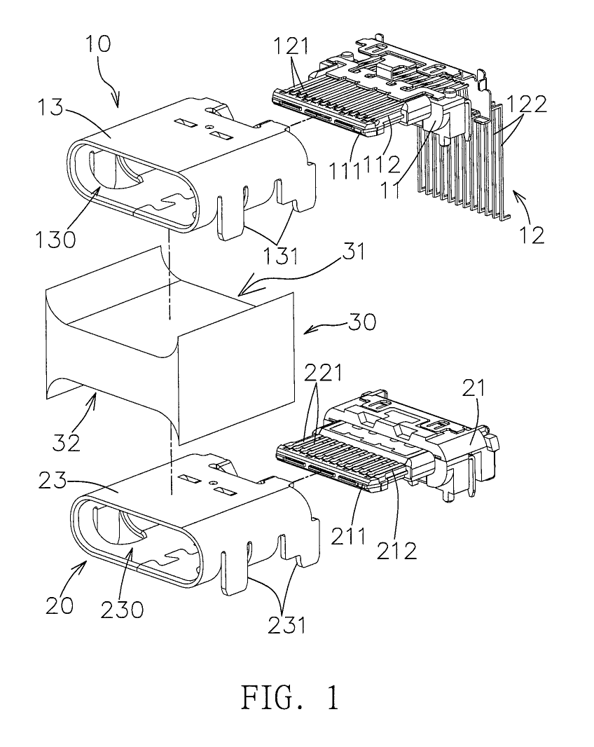

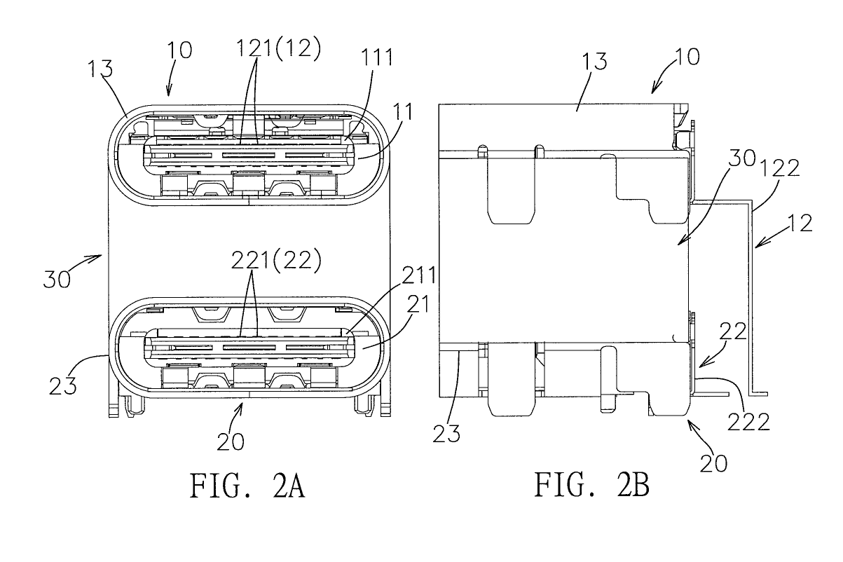

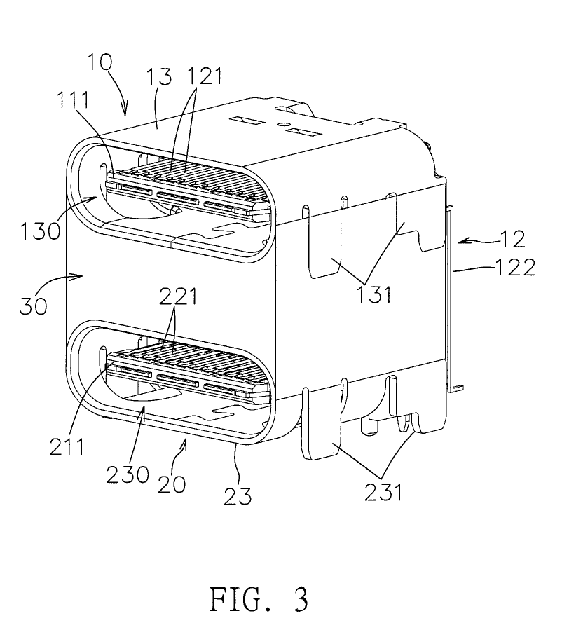

With reference to FIGS. 1 to 3 for a USB 3.1 Type-C stacking connector structure of the present invention, the USB 3.1 Type-C stacking connector structure comprises a first Type-C connector 10, a second Type-C connector 20 and a stacking seat 30, wherein the first Type-C connector 10 and second Type-C connector 20 are fixed onto both sides of the stacking seat 30 to form a USB 3.1 Type-C stacking connector assembly.

In the figure, the first Type-C connector 10 has a first insulating body 11, a plurality of first terminals 12, and a first steel casing 13, wherein the first insulating body 11 has a first flap 111 protruded from the front end of the first insulating body 11, and the first flap 111 has a plurality of first terminal grooves 112 formed on both upper and lower sides of the first flap 111 (Specifically, there are 12 first terminal grooves 112 formed on the upper and lower sides of the first flap 111), and the first insulating body 11 has a plurality of latching elements (not shown in the figure) for fixing and positioning the first steel casing 13. There are 24 first terminals 12, and each first terminal 12 includes a front-section first connecting terminal 121 and a rear-section bent first adapting terminal 122, wherein the first connecting terminal 121 of the 12 first terminals 12 is disposed on a first terminal groove 112 formed on the upper side of the first flap 111, and the first connecting terminal 121 of the other 12 first terminals 12 is disposed on the first terminal groove 112 formed on the lower side of the first flap 111, and the first adapting terminals 122 of the plurality of first terminals 12 are bent downward (in a direction as shown in the figure, and the same applies to the following). The first steel casing 13 is provided for covering the first insulating body 11 (including the first flap 111) and the plurality of first terminals 12 to provide a metal shielding effect, and the first steel casing 13 has a first docking opening 130 formed at the front end of the first steel casing 13 and disposed opposite to the first flap 111, and the first connecting terminal 121 is provided for the docking operation, and the first steel casing 13 has a plurality of first retaining legs 131 and retaining grooves (not shown in the figure), and the retaining grooves are provided for latching and combining the latching elements of the first insulating body 11 respectively.

The second Type-C connector 20 includes a second insulating body 21, a plurality of second terminals 22 and a second steel casing 23, wherein the second insulating body 21 has a second flap 211 protruded from the front end of the second insulating body 21, and the second flap 211 has a plurality of second terminal grooves 212 formed on both upper and lower sides of the second flap 211 (Specifically, there are 12 second terminal grooves 212 formed on both upper and lower sides of the second flap 211), and the second insulating body 21 has a plurality of latching elements (not shown in the figure) for latching and positioning the second steel casing 23. There are 24 second terminals 22, and each second terminal 22 includes a front-section second connecting terminal 221 and a rear-section bent second adapting terminal 222, wherein the second connecting terminals 221 of the 12 second terminals 22 are installed into in the second terminal grooves 212 formed on the upper side of the second flap 211, and the second connecting terminals 221 of the other 12 second terminal 22 are installed into the second terminal grooves 212 formed on the lower side of the second flap 211, and the second adapting terminals 222 of the plurality of second terminals 22 are bent downward. The second steel casing 23 is provided for covering the second insulating body 21 (including the second flap 211) and the plurality of second terminals 22 to provide a metal shielding effect, and the second steel casing 23 has a second docking opening 230 formed at the front end of the second steel casing 23 and configured to be opposite to the second flap 211, and the second connecting terminal 221 is provided for a docking operation, and the second steel casing 23 has a plurality of second retaining legs 231 and retaining grooves (not shown in the figure) formed thereon, and the retaining grooves are provided for latching and combining the latching elements of the second main body 21.

The stacking seat 30 has an upper first positioning portion 31 and a lower second positioning portion 32. In a preferred embodiment, the first positioning portion 31 and the second positioning portion 32 are substantially groove-shaped, wherein the first positioning portion 31 is provided for installing and positioning the first Type-C connector 10, and the first Type-C connector 10 is plugged and positioned to the first positioning portion 31 by using the first retaining leg 131 or by any suitable latching and tight fixing methods. The second positioning portion 32 is provided for installing and positioning the second Type-C connector 20, and the second Type-C connector 20 is fixed to the second positioning portion 32 by latching or tight fixing. Therefore, the first Type-C connector 10 is adjacent to the second Type-C connector 20, and the first Type-C connector 10 is preferably arranged to be parallel to the second Type-C connector 20. Specifically, the second Type-C connector 20 is arranged to be parallel to the first Type-C connector 10, so as to complete the configuration of the USB 3.1 Type-C stacking connector structure of the present invention.

With the aforementioned assemblies, the USB 3.1 Type-C stacking connector structure of the present invention can form a Type-C double-deck connector from the Type-C stacking assembly to achieve the effects of maximizing the transmission rate and the current performance of the Type-C and expanding the scope of applicability and the room of market development to improve the applications and economic benefits of the related product.

While the invention has been described by means of specific embodiments, numerous modifications and variations could be made thereto by those skilled in the art without departing from the scope and spirit of the invention set forth in the claims.

What is claimed is:

1. A USB 3.1 Type-C stacking connector structure, comprising:
a first Type-C connector;
a second Type-C connector; and
a stacking seat, provided for fixing the first Type-C connector and the second Type-C connector onto both sides of the stacking seat respectively to form a USB 3.1 Type-C stacking connector assembly.

2. The USB 3.1 Type-C stacking connector structure according to claim 1, wherein the first Type-C connector includes a first insulating body, a plurality of first terminals and a first steel casing, and the first insulating body has a first flap protruded from the front end of the first insulating body, and the first flap has a plurality of first terminal grooves formed on both upper and lower sides of the first flap, and the first steel casing covers the first insulating body and the plurality of first terminals, and the first steel casing has a first docking opening formed at the front end of the first steel casing.

3. The USB 3.1 Type-C stacking connector structure according to claim 2, wherein the first insulating body has a plurality of latching elements disposed thereon, and the first steel casing has a plurality of retaining grooves formed thereon and coupled to the latching elements respectively.

4. The USB 3.1 Type-C stacking connector structure according to claim 2, wherein the first terminal includes a front-section first connecting terminal and a rear-section bent first adapting terminal, and the first connecting terminal is disposed in the first terminal groove formed on the upper side of the first flap.

5. The USB 3.1 Type-C stacking connector structure according to claim 2, wherein the first steel casing has a plurality of first retaining legs formed thereon.

6. The USB 3.1 Type-C stacking connector structure according to claim 1, wherein the second Type-C connector includes a second insulating body, a plurality of second terminals, and a second steel casing, and the second insulating body has a second flap protruded from the front end of the second insulating body, and the second flap has a plurality of second terminal grooves formed on both upper and lower sides of the second flap respectively, and the second steel casing covers the second insulating body and the plurality of second terminals, and the second steel casing has a second docking opening formed at the front end of the second steel casing.

7. The USB 3.1 Type-C stacking connector structure according to claim 6, wherein the second insulating body has a plurality of latching elements disposed thereon, and the second steel casing has a plurality of corresponsive retaining grooves formed thereon and latched to the latching elements respectively.

8. The USB 3.1 Type-C stacking connector structure according to claim 6, wherein the second terminal includes a front-section second connecting terminal and a rear-section bent second adapting terminal, and the second connecting terminal is disposed in the second terminal groove formed on the upper side of the second flap.

9. The USB 3.1 Type-C stacking connector structure according to claim 6, wherein the second steel casing has plurality of second retaining legs disposed thereon.

10. The USB 3.1 Type-C stacking connector structure according to claim 1, wherein the stacking seat has an upper first positioning portion and a lower second positioning portion, and the first positioning portion is provided for installing and positioning the first Type-C connector, and the second positioning portion is provided for installing and positioning the second Type-C connector, and the first positioning portion and the second positioning portion are preferably in shape of a groove.

11. The USB 3.1 Type-C stacking connector structure according to claim 10, wherein the first Type-C connector is fixed to the first positioning portion by latching or tight positioning, and the second Type-C connector is fixed to the second positioning portion by latching or tight positioning.
